(19) United States
(12) Patent Application Publication
(10) Pub. No.: US 2025/0355273 A1
(43) Pub. Date: Nov. 20, 2025

(54) Rim-Arm Eyeglass Frame Assembly

(71) Applicant: Devin Collins, Charles Town, WV (US)

(72) Inventor: Devin Collins, Charles Town, WV (US)

(21) Appl. No.: 18/663,420

(22) Filed: May 14, 2024

(51) Int. Cl. G02C 5/04; G02C 13/00

(52) U.S. Cl. CPC G02C 5/04; G02C 13/001; G02C 2200/08

(57) ABSTRACT

Typically, eyeglasses have two main components: lenses and frames. Of the two, lenses are generally the more expensive component. My novel Rim-Arm frame would allow a user to purchase a variety of frames in different patterns and colors for use with just one set of lenses. Eyeglasses could be easily adapted to coordinate with apparel without the consumer having to invest in multiple sets of complete glasses. In the same sense, lenses can also be changed to fit the wearers daily activities. Along with complete interchangeability, the Rim-Arm frame facilitates hygienic cleaning of the frames and lenses particularly inside the rim of the frames where dirt can build up.

### CROSS-REFERENCE TO RELATED APPLICATIONS

Spectacles and Eyeglasses with Lens Retaining or Locking Means Patents (Class 351/86)

### BACKGROUND OF THE INVENTION

The present invention relates to the field of eyeglass manufacturing. Specifically, the present invention relates to an eyeglass frame design capable of allowing for the removal of lenses from the frame for the purposes of 1.) Replacing lenses with another pair of lenses; 2.) Placing lenses in an alternative Rim-Arm Eyeglass Frame (similar make); and 3.) Facilitating hygienic cleaning of lenses and frames.

Though there are many patents on record for eyeglasses with lens retaining of locking means in Class 351/86, none have yet to be brought to the eyeglasses market. The reason that these patents have sat undeveloped and unmanufactured is that the designs are too complex and thus too expensive to see production and compete against “standard” design eyeglasses.

### SUMMARY OF THE INVENTION

The Rim-Arm Eyeglass Frame Assembly is an eyeglass frame assembly designed for the easy removal and insertion of lenses that utilizes an arm section made from the material that makes up part of the lower rim around the lenses.

### BRIEF DESCRIPTION OF DRAWINGS

Included drawings:

FIG. 1: Illustration of rearview depiction with Rim-Arms unsecured according to present conception of the current design.

FIG. 2: Illustration of rearview depiction with Rim-Arms secured, according to present conception of the current design.

FIG. 3: Illustration of side view depiction with Rim-Arms unsecured, according to present conception of the current design.

FIG. 4: Illustration of side view depiction with Rim-Arms secured according to present conception of the current design.

FIG. 5: Illustration of dimensional depiction with Rim-Arms unsecured, according to present conception of the current design.

FIG. 6: Illustration of front view depiction with Rim-Arms secured, according to present conception of the current design.

### DETAILED DESCRIPTION OF THE INVENTION

An eyeglass frame assembly designed for the easy removal & insertion of lenses that utilizes an arm section mode from the material that makes up part of the rim around the lens. Each “Rim-Arm” is held in place in the upmost position by a securing means that holds it closed against the rest of the frame. When in the upmost position, the arms fit flush behind the rest of the frame, resulting in a seamless appearance from the front of the eyeglasses. When unsecured, the arm is free to move downward, allowing for removal or insertion of lenses from or into the frame. This design achieves the goal of lens removal & replacement while also successfully being commercially viable in manufacturing and production means to be brought onto the eyeglass market.

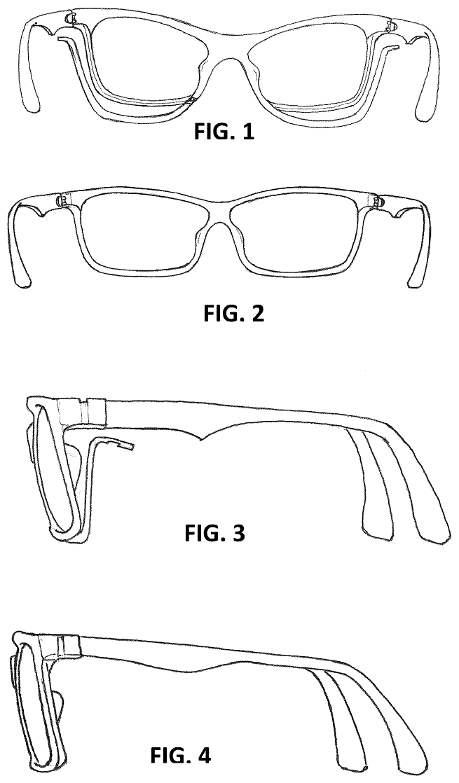

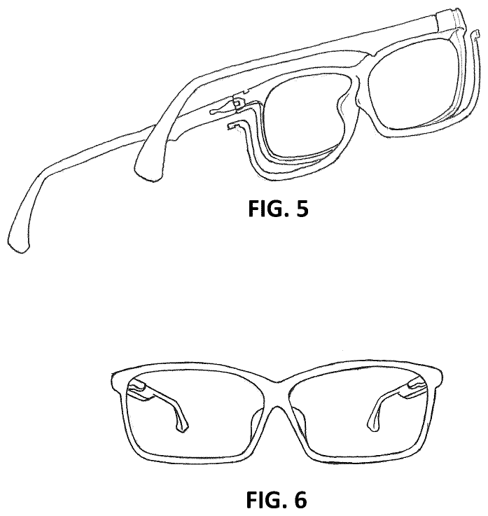

The concept graphic used to represent the invention in Illustration uses a simple clasp design to secure the Rim-Arms in their upmost position. The present invention was a novel design to create an eyeglasses frame capable of allowing for the removal of lenses from the frame for the purposes of replacing lenses with another pair of lenses, placing lenses in alternative eyeglass frame of proposed prototype, and facilitating hygienic cleaning of lenses and frame.
FIG. 1: Illustrates a rearview depiction of an embodiment of the present invention. One Rim-Arm (to the viewer's right) is directly attached to the rest of the frame. The other Rim-Arm (viewer's left) is attached at a pivoting point. Both Rim-Arms are shown unsecured.
FIG. 2: Illustrates a rearview depiction of an embodiment of the present invention. Both Rim-Arms are shown secured in their upmost position fitting flush to the rest of the eyeglass frame assembly.
FIG. 3: Illustrates a side view depiction of an embodiment of the present invention. The grooves both in the end piece and lock point of the “Rim-Arm” are to be secured by a “C” clasp piece that fits over both grooved areas when the Rim-Arm is in the upward position. The Rim-Arm is shown unsecured.
FIG. 4: Illustrates a side view depiction of the current conception of the present invention. The grooves both in the end piece and lock point of the “Rim-Arm” are to be secured by a “C” clasp piece that fits over both grooved areas when the Rim-Arm is in the upward position. The Rim-Arm is shown unsecured.
FIG. 5: Illustrates a dimensional depiction of the current conception of the present invention. This illustration is presented to emphasize detail and scope of the “RimArms” as shown unsecured.
FIG. 6: Illustrates a front view depiction of the current conception of the present invention. This illustration is to emphasize that when viewed from the front, the “Rim-Arms” and their securing means are hidden from view, appearing as if to be a standard make eyeglasses frame.

1. A novel addition to an eyeglass lens frame rim comprised of hinge and clasp attachments to a section of said rim creating a rim-arm that moves to facilitate the removal/insertion of an eyeglass lens from/into said frame for the purpose of:
(a) transferring said lenses from one said frame of rim-arm design to another said frame of said design, with said attachments easily adapted to suit frame material, e.g. plastic or metal, and manufacturing methods for said frame material,
(b) replacing said lenses in said frames with another pair of lenses of similar dimensions, and,
(c) facilitating hygienic cleaning of both said frames and lenses,
whereby one or more sets of said lenses can be used in multiple said frames having said rim-arm feature.
